(19) United States
(12) Patent Application Publication
(10) Pub. No.: US 2026/0181516 A1
(43) Pub. Date: Jun. 25, 2026

(54) BASE STATION MITIGATION OF FREQUENT HANDOVER OSCILLATION

(71) Applicant: T-MOBILE INNOVATIONS LLC, Overland Park, KS (US)

(72) Inventors: Mohd Khalil Bin ABU BAKAR, Herndon, VA (US); Krunal Mansukhlal MODASIYA, Aldie, VA (US)

(21) Appl. No.: 19/000,101

(22) Filed: Dec. 23, 2024

(51) Int. Cl. H04W 36/36; H04B 17/318; H04W 76/38

(52) U.S. Cl. CPC H04W 36/362; H04B 17/328; H04W 76/38

(57) ABSTRACT

Embodiments of the present disclosure are directed to systems and methods for making handover decisions. The method may include a first base station receiving a signal strength of each of the first base station and a second base station. The method may include determining the signal strengths of the first base station and the second base station are within a pre-determined threshold of each other. The method may include receiving physical resource block (PRB) availability of each of the first base station and the second base station. The method may include determining the PRB availability of the first base station is higher than the PRB availability of second base station. The method may include selecting the first base station with which the UE may attach to, remain attached to, and/or target for handover.

### SUMMARY

The present disclosure is directed, in part to making improved handover decisions, substantially as shown and/or described in connection with at least one of the figures, and as set forth more completely in the claims.

Frequent and rapid switching of a user equipment (UE) (e.g., a cell phone) between two or more base stations may be considered frequent handover oscillation, which may increase the likelihood of dropped calls and reduced quality of service (QoS) for the UE. The UE may detect that a base station has a stronger signal than the one it is actively attached on to, and may target a second base station for handover. However, the second base station may have a signal strength similar to the first base station, and, when the signal of the first base station increases slightly, the UE targets the first base station for handover. In such aspects, the frequent handover oscillation by the UE between the first base station and the second base station may result in inconsistent connectivity to the network. The present disclosure is directed to both proactive and reactive systems and methods of handing over UEs between neighboring base stations. Under the proactive framework, the handover scheme may be employed during initial search and selection by the UE and/or at subsequent handover decisions, preventing frequent handover oscillation from occurring. Under the reactive framework, the handover scheme described herein may be employed only when frequent handover oscillation is detected.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for making a handover decision in which implementations of the present disclosure may be employed;

FIG. 4 illustrates a flow diagram of an exemplary method for making a handover decision in which implementations of the present disclosure may be employed; and

FIG. 5 illustrates a flow diagram of an exemplary method for making a handover decision in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, frequent and rapid switching of a user equipment (UE) (e.g., a cell phone) between two or more base stations may be considered frequent handover oscillation. The UE may detect that a base station has a stronger signal than the one it is actively camped on to, and may elect to attach to a second base station. However, the second base station may have a signal strength very similar to the first base station, and, when the signal of the first base station increases slightly a short time after, the UE switches back to attach to the first base station. In such aspects, the frequent handover oscillation by the UE between the first and second base stations may result in inconsistent connectivity to the network. For example, the UE may be in an active voice call with another UE, and the quality of the call may vary based on the UE repeatedly switching between a first base station and a second base station. Further, in this example, the call may drop and/or fail such that the UE's experience is impacted by the very attempts to improve it.

Conventionally, frequent handover oscillation may be mitigated by implementation of a hysteresis margin, modification of a time-to-trigger (TTT) parameter, and/or implementation of complex handover algorithms. The hysteresis margin is a threshold amount of signal strength difference before a handover may be initiated. However, the hysteresis margin may limit necessary handovers and prevent some UEs from receiving higher quality of service at the second base station. The TTT parameter delays the handover decision until the signal strength of the second base station maintains the improved signal strength for a specified duration of time. However, this parameter may too limit necessary handovers, especially in fast-moving situations, such as when the UE is in a moving vehicle and moving between cells. Complex algorithms may be computationally intensive and utilize additional network resources to implement, and the complex algorithms may need to be adapted regularly based on network conditions, which requires additional labor on behalf of the mobile network operator (MNO).

In contrast to conventional solutions and to facilitate a more optimized use of the network, the present disclosure is directed to both proactive and reactive systems and methods of handing over UEs between neighboring base stations. Under the proactive framework, the handover scheme may be employed during initial search and selection by the UE and later attachment decisions by the UE, preventing frequent handover oscillation from occurring to begin with. Under the reactive framework, the handover scheme described herein may be employed only when frequent handover oscillation is detected. The handover scheme may be employed when the UE is in an active voice call, such that the UE maintains a stable connection to a single base station during the duration of the voice call.

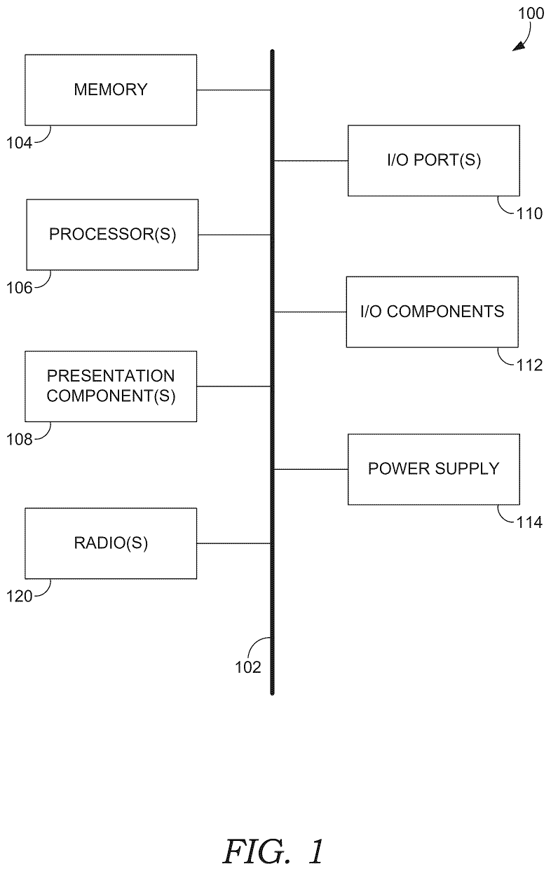

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

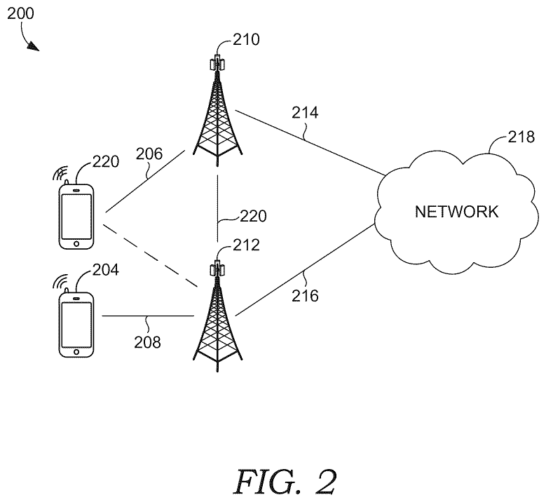

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment 200 be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as a first UE 202 and/or a second UE 204, one or more base stations, such as a first base station 210 and/or a second base station 212, and a core network 218, though in some implementations, it may not be necessary for certain features to be present. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like). In the network environment 200, at least the first UE 202 is positioned in the coverage areas of each of the first base station 210 and/or the second base station 212, represented in FIG. 2 as a dotted line between the first UE 202 and the second base station 212.

The network environment 200 comprises one or more of the first base station 210 and/or the second base station 212 to which the first UE 202 and the second UE 204 may potentially connect to (also referred to as ‘camping on,’ ‘attaching,’ in the industry). Though network environment 200 is illustrated with both the first base station 210 and the second base station 212, one skilled in the art will appreciate that more base stations may be present in any particular network environment. Each of the first base station 210 and/or the second base station 212 of the network environment 200 is configured to wirelessly communicate with UEs, such as the first UE 202 and/or the second UE 204. In aspects, any of first base station 210 and/or the second base station 212 may communicate with one or more of the first UE 202 and/or the second UE 204 using any wireless telecommunication protocol desired by a network operator, including but not limited to 3G, 4G, 5G, 6G, 802.11x and the like. In aspects, the first base station 210 and the second base station 212 are active set neighbors such that the UE 302 may monitor reference signals from the first base station 210 and the second base station 212, and may ultimately target the base station with stronger reference signals.

Each base station of the first base station 210 and the second base station 212 is configured to transmit and receive one or more of a first signal 206 and/or a second signal 208 between a base station and the first UE 202 and between a base station and the second UE 204. The one or more of the first signal 206 and the second signal 208 comprise one or more uplink signals for which the first base station 210 and/or the second base station 212 are configured to receive from the first UE 202 and/or second UE 204. The one or more of the first signal 206 and the second signal 208 may also comprise downlink signals for which the first base station 210 and/or the second base station 212 are configured to communicate to the first UE 202 and/or the second UE 204. In response to receiving certain requests from the first UE 202 and/or the second UE 204, the first base station 210 and/or the second base station 212 may communicate with the core network 218 via a first backhaul 214 and a second backhaul 216. For example, in order for the first UE 202 to connect to a desired network service (e.g., PSTN call, voice over LTE (VoLTE) call, voice over new radio (VoNR), data, or the like), the first UE 202 may communicate an attach request to the first base station 210, which may, in response, communicate a registration request to the core network 218 via the first backhaul 214.

In aspects, the first base station 210 and/or the second base station 212 may communicate with each other via an interface 220. In aspects, such as those shown in FIG. 2, the first base station 210 and/or the second base station 212 may directly communicate via the interface 220. In aspects, the first base station 210 and/or the second base station 212 communicate indirectly via the network 218 (e.g., the interface 220 is routed through the network 218). In some aspects, the interface 220 comprises an X2 interface and/or an Xn interface.

Relevant to the present disclosure, the first UE 202 may be attached to the first base station 210, and the first UE 202 may cease its connection with the first base station 210 in favor of the second base station 212 when the first UE 202 detects the second base station 212 has a stronger signal strength. However, the first base station 210 may be, at a first time, −100 decibel-milliwatts (dBm) and the second base station 212 may be −101 dBm, for example, and these values may vary such that, at a second time, the signal strength from the second base station 212 exceeds that of the first base station 210. In this example, the first UE 202, at the first time, undergoes a handover to the second base station 212 (i.e., ceases its connection to the first base station 210 and attaches to the second base station 212), and at a second time, the first UE 202 undergoes a handover to the first base station 210. In this example, the first base station 210 and the second base station 212 may continue fluctuating in signal strength such that the first UE 202 bounces between the first base station 210 and the second base station 212. This phenomenon, frequent handover oscillation, may reduce quality of service (QoS), cause increased call drops, and consume network resources.

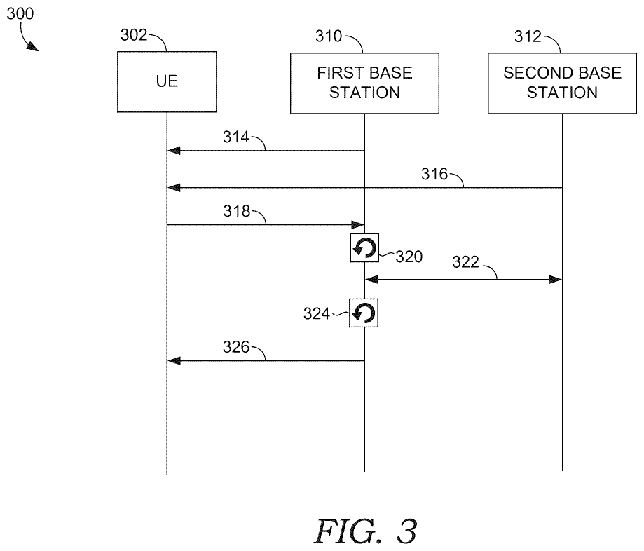

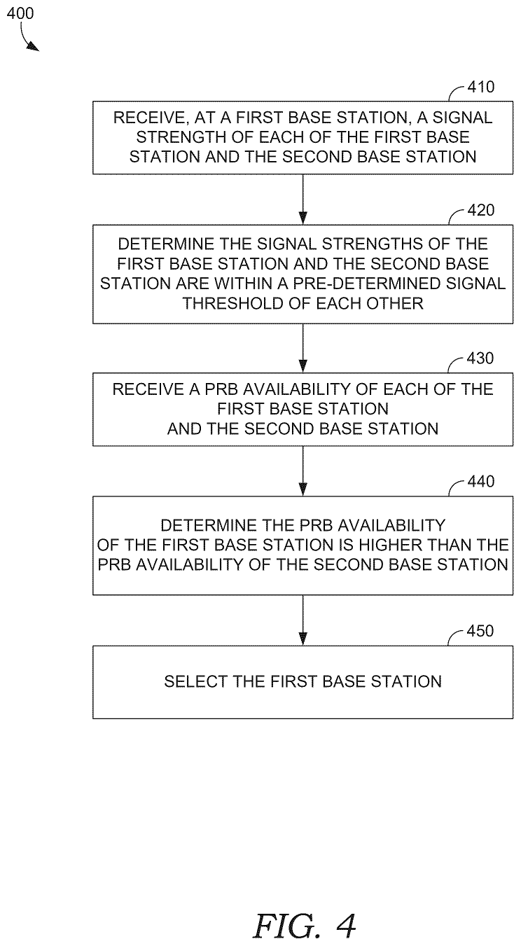

As will be further discussed with respect to FIGS. 3-4, the first base station 210 and/or the second base station 212 may be configured with logic to determine whether the first UE 202 should undergo a handover to the second base station 212. In aspects, the first base station 210 receives the signal strength of each of the first base station 210 and the second base station 212 (e.g., from the first UE 202) and determines they are within a pre-determined signal threshold of each other (e.g., ±1 dBm). The first base station 210 may then receive a physical resource block (PRB) availability of each of the first base station 210 and the second base station 212 (e.g., from the second base station 212 via the interface 220). With this information, the first base station 210 may determine that while one base station has a higher signal strength, the other has higher PRB availability, and may instruct the first UE 202 to attach to, remain attached to, and/or undergo a handover to the base station with the lower signal strength and higher PRB availability.

Turning now to FIG. 3, a call flow diagram is illustrated in accordance with one or more aspects of the present disclosure. A call flow 300 may be said to exist between one or more components discussed in greater detail herein and is not meant to exhaustively show every interaction that would be necessary to practice the invention, so as not to obscure the present disclosure, but is instead meant to illustrate one or more potential interactions between components. The call flow 300 may be relevantly said to include a UE 302 (e.g., the first UE 202 and/or the second UE 204), a first base station 310 (e.g., the first base station 210), and a second base station 312 (e.g., the second base station 212). FIG. 3 may include and/or reference any one or more aspects described with respect to FIG. 2.

At a first step 314, the first base station 310 communicates a references signal to the UE 302. In aspects, the UE 302 may receive the reference signal from the first base station 310, and from this reference signal the UE 302 may determine a signal strength of the first base station 310. In aspects, the UE 302 determines reference signal received power (RSRP), reference signal received quality (RSRQ), signal to interference plus noise ratio (SINR), and/or received signal strength indicator (RSSI) of the first base station 310.

At a second step 316, the second base station 312 communicates a reference signal to the UE 302. In aspects, the UE 302 may receive the reference signal from the second base station 312 and may determine a signal strength of the second base station 312. In aspects, the UE 302 determines RSRP, RSRQ, SINR, and/or RSSI of the second base station 312.

At a third step 318, the first base station 310 receives the signal strength of each of the first base station 310 and the second base station 312 from the UE 302. In aspects, the received signal strengths are one or more of RSRP, RSRQ, SINR, and/or RSSI associated with each of the first base station 310 and the second base station 312. In aspects, the first base station 310 determines whether the signal strength of each of the first base station 310 and the second base station 312 are within a pre-determined signal threshold of each other.

As described briefly above, the signal strength of each of the first base station 310 and the second base station 312 may within a small range of each other, which may at least partially cause the frequent handover events associated with frequent handover oscillation. The pre-determined signal threshold between the signal strength of each of the first base station 310 and the second base station 312 may be customized by the mobile network operator. In aspects, the pre-determined signal threshold is within ±1 dBm, ±2 dBm, ±3 dBm, ±4 dBm, and the like, such as up to ±10 dBm and possibly still higher. Thus, for example, a pre-determined signal threshold of ±3 dBm is met when the signal strength of the first base station 310 is within ±2 dBm of the signal strength of the second base station 312.

At a fourth step 320, the first base station 310 performs logic to determine whether to proceed with the call flow 300. In some aspects of the call flow 300, the first base station 310 may determine the signal strength of each of the first base station 310 and the second base station 312 is within the pre-determined signal threshold of each other and may continue the call flow 300. In other aspects of the call flow 300, the first base station 310 may determine one of the first base station 310 or the second base station 312 has a signal strength that falls outside of the pre-determined signal threshold of each other. For example, the pre-determined signal threshold is ±1 dBm, and when the signal strength of the first base station 310 is within ±3 dBm of the signal strength of the second base station 312, the signal strengths fall outside of the pre-determined signal threshold. In such aspects, the first base station 310 may instruct the UE 302 to attach to the base station with the higher signal strength.

At a fifth step 322, the first base station 310 receives information from the second base station 312, such as a physical resource block (PRB) availability of the second base station 312. PRB availability includes an indication of the number of PRBs available at the base station, which may be assigned to the UE 302. In aspects, as described briefly with respect to FIG. 2, the first base station 310 and the second base station 312 may communicate, such as via an interface (e.g., the interface 220 of FIG. 2). The first base station 310, in some aspects, may request the PRB availability from the second base station 312 and/or the second base station 312 may communicate its PRB availability to the first base station 310.

At the fifth step 322, the first base station 310 may alternatively receive an indication of the UE's 302 distance from the first base station 310 and the second base station 312. In aspects, the indication is a timing advance (TA) parameter of the UE's communications to the first base station 310 and the second base station. The first base station 310, in some aspects, may request the indication from the second base station 312 and/or the second base station 312 may communicate the indication to the first base station 310.

At a sixth step 324, the first base station 310 performs logic to determine a handover decision associated with the UE 302. As used herein, “handover decision” includes selecting a base station to which the UE 302 may attach to (e.g., the UE 302 is performing cell search and selection), remain attached to, and/or may target for handover.

In aspects, the handover decision may include the first base station 310 determining whether the PRB availability falls outside of a pre-determined PRB threshold of each other. In some aspects, the pre-determined PRB threshold may be ±10 PRBs, ±20 PRBs, ±30 PRBs, ±50 PRBs, and the like, such as up to ±100 PRBs and possibly still higher. The handover decision may include the first base station 310 selecting a base station (e.g., to which the UE 302 may connect). In aspects, the first base station 310 selects the base station with the higher PRB availability. For example, if the first base station 310 and the second base station 312 have a similar signal strength (e.g., within the pre-determined signal threshold), but the second base station 312 has a higher PRB availability than the first base station 310 (e.g., outside of the pre-determined PRB threshold), the first base station 310 may select the second base station 312. In other aspects, no threshold is considered and the first base station 310 selects the base station with the higher PRB availability.

At the sixth step 324, the handover decision may include the first base station 310 determining the TA associated with the first base station 310 and/or the TA associated with the second base station 312 is outside of a pre-determined TA threshold of each other. In aspects, the pre-determined TA threshold may be ±1 microseconds (μs), ±3 μs, ±5 μs, ±10 μs, ±15 μs, and the like, and possibility still higher. In aspects, the first base station 310 selects the base station with the lower TA parameter value. For example, if the first base station 310 and the second base station 312 have a similar signal strength (e.g., within the pre-determined signal threshold), but the UE 302 is much closer geographically to the first base station 310 (e.g., outside of the pre-determined TA threshold), the first base station 310 may select the first base station 310 (i.e., itself).

At a seventh step 326, once the first base station 310 makes the handover decision (e.g., selects a base station), the first base station 310 may inform the UE 302 of the decision such as to guide and/or instruct the UE 302 to attach to one of the first base station 310 or the second base station 312. For example, the first base station 310 may communicate radio resource control (RRC) communications to the UE 302 informing the UE 302 of the selected base station and/or instructing the UE 302 to attach to and/or undergo a handover in favor of the selected base station.

The call flow 300 may be implemented in various ways. For example, the call flow may be initiated when the UE 302 performs cell search and selection such that the UE 302 is directed to the selected base station without ever experiencing frequent handover oscillation, thus preventing its negative impacts. In another example, the UE 302 may initially be attached to the first base station 310 and after the handover decision is made during the call flow 300, the first base station 310 may cause the UE 302 to attach to the second base station 312. In yet another example, the UE 302 may initially be attached to the first base station 310 and after the handover decision is made during the call flow 300, the first base station 310 may cause the UE 302 to remain attached to the first base station 310.

The call flow 300 may be implemented proactively and/or reactively. In proactive approaches, the call flow 300 may be utilized by one or more base stations within the network (e.g., the first base station 310, the second base station 312) such that, during cell search and selection, any one or more UEs (e.g., the UE 302) selects a base station with a lesser likelihood of frequent handover oscillation. In reactive approaches, the call flow 300 may be utilized upon the first base station 310 detecting frequent handover oscillation between the UE 302, the first base station 310, the second base station 312, and in aspects, one or more additional base stations. In aspects, the first base station 310 detects a plurality of handover events within a pre-determined time period (e.g., within 1 minute, 2 minutes, 5 minutes) exceeds a handover threshold (e.g., 3 handovers within 1 minute, 10 handovers within a minute, 20 handovers within 5 minutes). Upon the detection, the first base station 310 implements the call flow 300.

In aspects, the call flow 300 is a user-friendly, customizable solution. Conventional algorithms are typically difficult to adjust as needed, and such adjustment may introduce errors and/or bugs into the algorithm. In contrast, the call flow 300 enables MNOs to customize the pre-determined signal threshold, the pre-determined PRB threshold, the predetermined TA threshold, and/or the pre-determined handover threshold with ease due to the simpler logic implemented at the first base station 310. Further, the logic of the first base station 310 may reduce the amount of network resources consumed when providing a solution, as complex algorithms often consume large quantities of network resources. The logic of the first base station 310 may be more scalable and may be implemented across a wider array of base stations compared to complex algorithms.

Turning now to FIG. 4, a flow chart is provided that illustrates one or more aspects of the present disclosure relating to a method 400 for making a handover decision. At a first step 410, a first base station (e.g., the first base station 310 of FIG. 3, the first base station 210 of FIG. 2) receives a signal strength of each of the first base station and a second base station (e.g., the second base station 312 of FIG. 3, the second base station 212 of FIG. 2). In aspects, the signal strength is one of RSRP, RSRQ, SINR, and RSSI, as described with respect to FIG. 3.

At a second step 420, the first base station determines the signal strengths of the first base station and the second base station are within a pre-determined signal threshold of each other. In aspects, the pre-determined signal threshold is ±1 dBm, ±2 dBm, and the like, as described with respect to FIG. 3. In some aspects, such as when the method 400 is implemented reactively, the second step 420 only occurs after the first base station detects frequent handover oscillation, such as by determining a plurality of handover events within a pre-determined time period exceeds a pre-determined handover threshold, as described with respect to FIG. 3.

At a third step 430, the first base station receives a PRB availability of each of the first base station and the second base station. In aspects, the first base station communicates with the second base station to receive the PRB availability of the second base station via an interface (e.g., the interface 220 of FIG. 2). In aspects, the first base station receives its own PRB availability by accessing and/or interpreting information associated with the first base station. In some aspects, the first base station determines the PRB availabilities of the first base station and the second base station are outside of a pre-determined threshold (e.g., the pre-determined PRB threshold described with respect to FIG. 3).

At a fourth step 440, the first base station determines the PRB availability associated with the first base station is higher than the PRB availability of the second base station, as described with respect to FIG. 3. For example, the first base station may have a PRB availability of 80 PRBs and the second base station may have a PRB availability of 40 PRBs.

At a fifth step 450, the first base station selects the first base station. In aspects, the first base station selects the first base station based on its PRB availability and its signal strength, each relative to that of the second base station. In aspects, based on the selection, the first base station may cause the UE to attach to, remain attach to, and/or target handover of the selected base station.

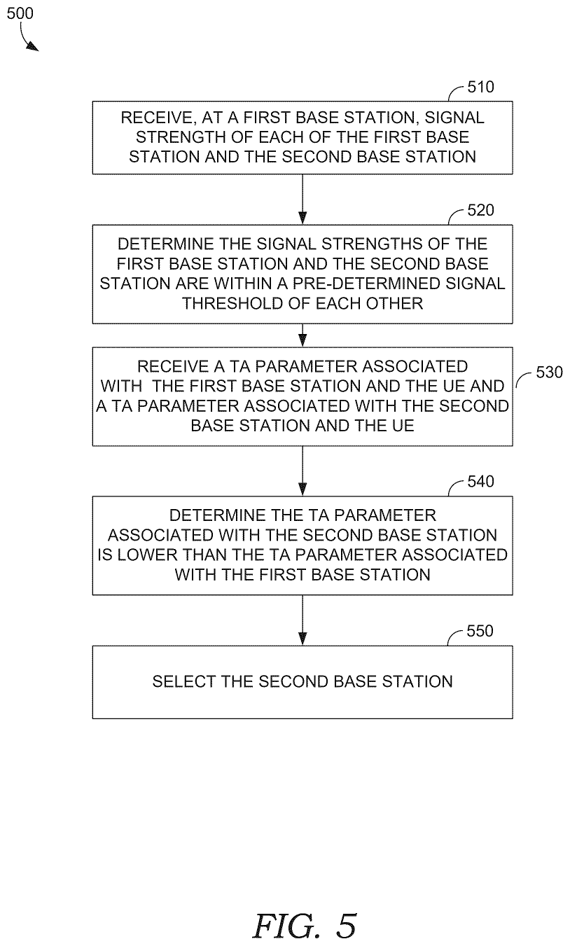

Turning now to FIG. 5, a flow chart is provided that illustrates one or more aspects of the present disclosure relating to a method 500 for making a handover decision. At a first step 510, a first base station (e.g., the first base station 310 of FIG. 3, the first base station 210 of FIG. 2) receives a signal strength of each of the first base station and a second base station (e.g., the second base station 312 of FIG. 3, the second base station 212 of FIG. 2), as described with respect to FIGS. 3-4.

At a second step 520, the first base station determines the signal strengths of the first base station and the second base station are within a pre-determined threshold (e.g., a pre-determined signal threshold) of each other, as described with respect to FIGS. 3-4.

At a third step 530, the first base station receives a timing advance (TA) parameter associated with each of the first base station, the second base station, and the UE (e.g., a TA parameter associated with the first base station and the UE and a TA parameter associated with the second base station and the UE), which may reflect a distance of the UE from the first base station and a distance of the UE from the second base station. In some aspects, the TA associated with the first base station 310 and/or the TA associated with the second base station 312 is outside of a pre-determined TA threshold of each other, as described with respect to FIG. 3.

At a fourth step 540, the first base station determines the TA parameter associated with the second base station is lower than the TA parameter associated with the first base station. In aspects, the lower TA parameter signals the UE is closer to the second base station and would thus be a better selection over the first base station given their similar signal strengths (e.g., reduced interference, higher data rates, better QoS, lower latency, increased throughput).

At a fifth step 550, the first base station selects the second base station. In aspects, the first base station selects the second base station based on its TA parameter and its signal strength, each relative to that of the second base station. In aspects, based on the selection, the first base station may cause the UE to attach to, remain attach to, and/or target handover of the selected base station.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for making a handover decision, the method comprising:
receiving, at a first base station, a signal strength of each of the first base station and a second base station;
determining the signal strengths of the first base station and the second base station are within a pre-determined signal threshold of each other;
receiving physical resource block (PRB) availability of each of the first base station and the second base station;
determining the PRB availability of the first base station is higher than the PRB availability of second base station; and
based on the determining, selecting the first base station.

2. The method of claim 1, wherein the pre-determined signal threshold is ±2 dBm.

3. The method of claim 1, wherein the pre-determined signal threshold is ±1 dBm.

4. The method of claim 1, wherein the signal strength is received signal strength power (RSRP).

5. The method of claim 1, wherein the signal strength is reference signal quality (RSRQ).

6. The method of claim 1, wherein a user equipment (UE) communicates the signal strength of the first base station and the second base station to the first base station.

7. The method of claim 1, wherein a UE is performing cell search and selection, and after the selecting, the UE attaches to the first base station.

8. A method for making a handover decision, the method comprising:
detecting, by a first base station, a plurality of handover events within a pre-determined time period, the plurality of handover events exceeding a handover threshold, the plurality of handover events associated with a user equipment (UE) and the first base station and a second base station;
receiving a signal strength of each of the first base station and the second base station;
determining the signal strengths of the first base station and the second base station are within a pre-determined signal threshold of each other;
receiving a physical resource block (PRB) availability of each of the first base station and the second base station;
determining the PRB availability of the second base station is higher than the first base station; and
based on the determining, selecting the second base station.

9. The method of claim 8, wherein the pre-determined signal threshold is ±2 dBm.

10. The method of claim 8, further comprising causing the UE to attach to the second base station.

11. The method of claim 8, wherein the signal strength is received signal strength power (RSRP).

12. The method of claim 8, wherein the signal strength of the first base station is higher than the signal strength of the second base station.

13. The method of claim 8, wherein the UE is initially attached to the first base station, wherein based on the selecting, the UE is handed over to the second base station.

14. The method of claim 8, wherein the PRB availability of the second base station is received by the first base station over an X2 interface.

15. A method for reactively making a handover decision, the method comprising:
detecting, by a first base station, a plurality of handover events within a pre-determined time period, the plurality of handover events exceeding a handover threshold, the plurality of handover events associated with a user equipment (UE), the first base station, and a second base station;
receiving a signal strength of each of the first base station and the second base station;
determining the signal strengths of the first base station and the second base station are within a pre-determined signal threshold of each other;
receiving a timing advance (TA) parameter associated with the first base station and the UE and a TA parameter associated with the second base station and the UE;
determining the TA parameter associated with the first base station is lower than the TA parameter associated with the second base station; and
based on the determining, selecting the first base station.

16. The method of claim 15, wherein the pre-determined signal threshold is ±2 dBm.

17. The method of claim 15, wherein the signal strength is received signal strength power (RSRP).

18. The method of claim 15, wherein the signal strength of the second base station is higher than the signal strength of the first base station.

19. The method of claim 15, wherein the UE is initially attached to the first base station, wherein based on the selecting, the UE remains attached to the first base station.

20. The method of claim 15, wherein the TA parameter associated with the second base station is received by the first base station over an X2 interface.
